(19) United States
(12) Patent Application Publication
(10) Pub. No.: US 2017/0374384 A1
(43) Pub. Date: Dec. 28, 2017

(54) PALETTE CODING FOR NON-4:4:4 SCREEN CONTENT VIDEO

(71) Applicant: Vid Scale, Inc., Wilmington, DE (US)

(72) Inventors: Xiaoyu Xiu, San Diego, CA (US); Yan Ye, San Diego, CA (US); Yuwen He, San Diego, CA (US)

(73) Assignee: Vid Scale, Inc., Wilmington, DE (US)

(21) Appl. No.: 15/543,852

(22) PCT Filed: Jan. 14, 2016
(86) PCT No.: PCT/US2016/013406

§ 371 Date: Jul. 14, 2017

Related U.S. Application Data
(60) Provisional application No. 62/103,419, filed on Jan. 14, 2015.

(51) Int. Cl. H04N 19/593; H04N 19/186; H04N 19/182; H04N 19/94; H04N 19/176

(52) U.S. Cl. CPC H04N 19/593; H04N 19/94; H04N 19/176; H04N 19/182; H04N 19/186

(57) ABSTRACT

A video coding device may receive a video bit-stream that carries a video captured in a non-4:4:4 chroma format. A palette mode may be used to decode the video bit-stream. The video bit-stream may include data defining a palette table and a palette index map in a 4:4:4 chroma format for the current block. A luma sample value for a luma sample position in the non-4:4:4 chroma format may be determined based on the luma sample position, the palette index map and the palette table. A chroma sample position associated with the 4:4:4 chroma format on the palette index map may be derived based on the luma component to chroma component resolution ratio in the non-4:4:4 chroma format. A chroma sample value for a chroma sample position in non-444 chroma format may be determined based on the derived chroma sample position, the palette index map and the palette table.

### CROSS REFERENCE TO RELATED APPLICATIONS

This application claims the benefit of U.S. Provisional Patent Application No. 62/103,419, filed on Jan. 14, 2015, the disclosures of which are hereby incorporated by reference in their entirety.

### BACKGROUND

Screen content sharing applications may be utilized for remote desktop, video conferencing and/or mobile media presentation applications. Industries may have application requirements. Screen content may comprise numerous blocks with several colors (e.g., major colors) and/or sharp edges since there may be sharp curves and texts inside, for example, as compared to natural video content. Video compression may be utilized to encode screen content and/or transmit screen content to a receiver. Some video compression implementations may not fully characterize the feature of screen content and/or may lead to a low compression performance. The reconstructed picture may have quality issues. For example, the curves and texts may be blurred and it may be difficult to recognize the curves and texts. A screen compression implementation may be utilized to effectively reconstruct screen content.

Palette-based coding may be used in recursive quad-tree framework of HEVC, for example, for coding screen content by considering characteristics of screen content.

### SUMMARY

A video coding device may be configured to receive a video bit-stream for non-4:4:4 video. A video bit-stream for a video in a non-4:4:4 chroma format may be decoded in a palette mode. For example, the bit-stream may include data defining a palette table and a palette index map in a 4:4:4 chroma format for the current block. For a luma sample position in the non-4:4:4 chroma format, a respective luma sample value may be determined based on the luma sample position, the palette index map and the palette table. A color index value associated with the luma sample position may be determined, and used to look up the respective luma sample value in the palette table. For a chroma sample position in the non-4:4:4 chroma format, a chroma sample position associated with the 4:4:4 chroma format on the palette index map may be derived based on the luma component to chroma component resolution ratio in the non-4:4:4 chroma format. A respective chroma sample value for the chroma sample position in the non-4:4:4 chroma format may be determined based on the derived chroma sample position associated with 4:4:4 chroma format, the palette index map and the palette table.

For a chroma sample position in the non-4:4:4 chroma format, the chroma sample value for the chroma sample position may be determined based on whether the chroma sample position is associated with a luma component. The determination may be based on the chroma sample position. The chroma sample value for the chroma sample position may be discarded when it is determined that the chroma sample position is associated with the luma component only. The non-4:4:4 chroma format may be 4:2:0, 4:2:2 or 4:0:0 chroma format.

When it is determined that a sample position in a coding unit (CU) is associated with an escape color, the sample position and the non-4:4:4 chroma format may be used to determine whether a chroma component associated with the sample position is signaled. The chroma sample value may be recovered when the chroma component associated with the sample position is signaled. A decoded escape color value for the chroma component associated with the sample position may be used to recover the chroma sample value.

Whether the sample position is associated with an escape color may be determined based on a color index value associated with the sample position on the palette index map. When the sample position is associated with at least one chroma component in the non-4:4:4 chroma format, the chroma component associated with the sample position may be signaled. When the sample position is only associated with a luma component in the non-4:4:4 chroma format, the chroma component associated with the sample position may be not signaled.

A video coding device may encode a video captured in a non-4:4:4 chroma format using palette encoding. For example, a video block associated with a non-4:4:4 chroma format may include chroma sample positions and luma sample positions. The chroma samples may be upsampled in accordance with a 4:4:4 chroma format. A palette table and a palette index map associated with the 4:4:4 chroma format may be derived based on the upsampled chroma sample positions and the luma sample positions. The palette table and the palette index map associated with the 4:4:4 chroma may be encoded in the video bit-stream. The bit-stream may include chroma sample values associated with luma-only sample positions. Chroma sample positions near luma sample positions may be used for upsampling chroma sample positions. The chroma sample positions near the luma sample positions may be the chroma sample positions closest in phase distance to the luma sample positions. An interpolation-based upsampling may be used for upsampling the plurality of chroma sample positions. The interpolation-based upsampling may be based on the chroma sample positions near a luma sample position and the phase distance between the chroma sample and the luma sample positions.

The video coding device may determine whether a sample position is associated with an escape color. When the device determines that the sample position is associated with an escape color, the device may determine whether to signal a chroma component associated with the sample position based on the sample position and the non-4:4:4 chroma format. The device may encode the chroma component in a video bit-stream based on a determination that the chroma component associated with the sample position is to be signaled. The device may encode an escape color value for the chroma component associated with the sample position. The encoder may determine that a chroma sample value associated with the sample position may be signaled on the condition that the sample position is associated with at least one chroma sample value in the non-4:4:4 chroma format. The encoder may determine that a chroma sample value associated with the sample position may not be signaled on the condition that the sample position is only associated with a luma sample value.

### BRIEF DESCRIPTION OF THE DRAWINGS

FIG. 1 illustrates an example general block diagram of a block-based video encoding device.

FIG. 2 illustrates an example general block diagram of a block-based video decoding device.

FIG. 3 illustrates an example screen content sharing system.

FIG. 4 illustrates an example block diagram of the coding process of palette coding.

FIG. 5 illustrates an example sampling grid of luma and chroma components in a 4:4:4 chroma format.

FIG. 6 illustrates an example sampling grid of luma and chroma components in a 4:2:0 chroma format.

FIG. 7 illustrates an example sampling grid of luma and chroma components in a 4:2:2 chroma format.

FIG. 8 illustrates an example block diagram of the encoding process of palette coding for non-4:4:4 videos.

FIG. 9 illustrates an example block diagram of the decoding process of palette coding for non-44:4 videos.

FIG. 10A is a system diagram of an example communications system in which one or more disclosed embodiments may be implemented.

FIG. 10B is a system diagram of an example wireless transmit/receive unit (WTRU) that may be used within the communications system illustrated in FIG. 10A.

FIG. 10C is a system diagram of an example radio access network and an example core network that may be used within the communications system illustrated in FIG. 10A.

FIG. 10D is a system diagram of another example radio access network and another example core network that may be used within the communications system illustrated in FIG. 10A.

FIG. 10E is a system diagram of another example radio access network and another example core network that may be used within the communications system illustrated in FIG. 10A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Video coding systems may be used to compress digital video signals, for example, to reduce the storage need and/or transmission bandwidth of such signals. There are various types of video coding systems, such as block-based, wavelet-based, and object-based systems. Block-based hybrid video coding systems may be widely used and deployed. Examples of block-based video coding systems include international video coding standards such as the MPEG1/2/4 part 2, H.264/MPEG-4 part 10 AVC and VC-1 standards.

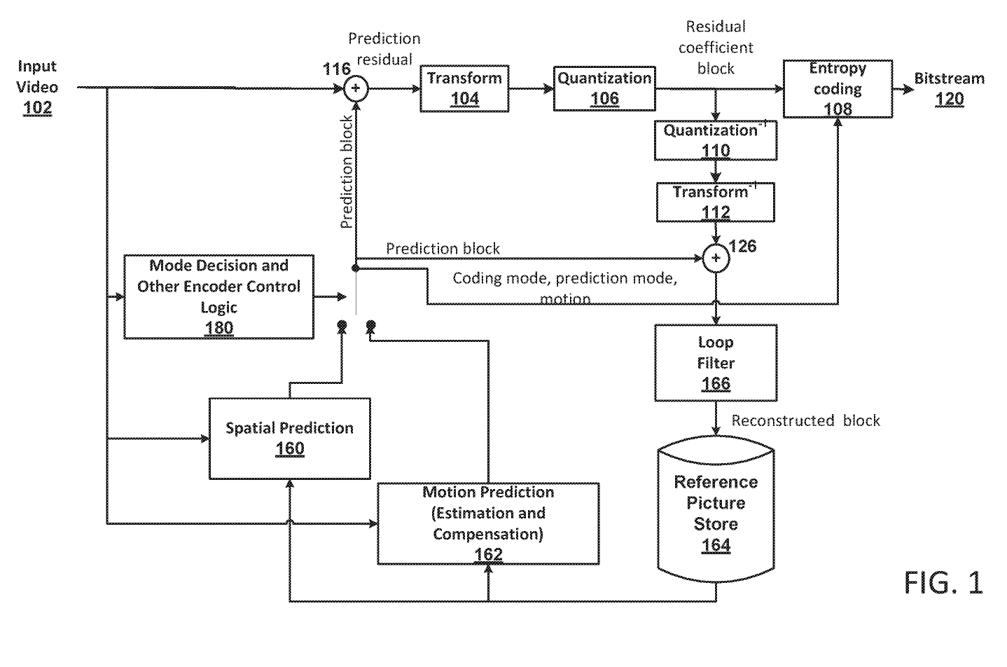

FIG. 1 is a general block diagram of a block-based video coding device. FIG. 1 illustrates the block diagram of a generic block-based hybrid video coding system. The input video signal 102 may be processed block by block. The video block unit may comprise 16×16 pixels. Such a block unit may be referred to as a macroblock or MB. In High Efficiency Video Coding (HEVC), extended block sizes (e.g., a “coding unit” or CU) may be used to compress (e.g., efficiently compress) high resolution (e.g., 1080p, etc.) video signals. In HEVC, a CU may be 64×64 pixels. A CU may be partitioned into prediction units or PU. Separate prediction modes may be applied to a PU. For an (e.g., each) input video block (e.g., MB or CU), spatial prediction 160 and/or temporal prediction 162 may be performed. Spatial prediction or “intra prediction” may use pixels from a coded neighboring block in the same or neighboring video picture/slice to predict the current video block. Spatial prediction may reduce spatial redundancy in the video signal. Temporal prediction may be referred to as “inter prediction” or “motion compensated prediction.” Temporal prediction may use pixels from a coded video picture to predict the current video block. Temporal prediction may reduce temporal redundancy in the video signal. Temporal prediction signal for a video block may be signaled by one or more motion vectors that may indicate the amount and the direction of motion between the current block and its reference block. If multiple reference pictures are supported, then for one or more (e.g., each) video block, the reference picture index may be sent. The reference index may be used to identify from which reference picture in the reference picture store 164 the temporal prediction signal originates or comes. The mode decision block 180 in the video coding device may choose a prediction mode (e.g., the best prediction mode), for example, after spatial and/or temporal prediction. The mode decision block 180 in the video coding device may choose a prediction mode (e.g., the best prediction mode), for example, based on a rate-distortion optimization method. The prediction block may be subtracted from the current video block 116. The prediction residual may be de-correlated, for example, using transform 104 and quantized 106 to achieve a target bit-rate. The quantized residual coefficients may be inverse quantized 110 and/or inverse transformed 112 to form the reconstructed residual. The reconstructed residual may be added to the prediction block 126 to form the reconstructed video block. In-loop filtering 166, such as deblocking filter and adaptive loop filters, may be applied to the reconstructed video block, for example, before it is put in the reference picture store 164 and/or used to code future video blocks. To form the output video bit-stream 120, coding mode (e.g., inter or intra), prediction mode information, motion information, and quantized residual coefficients may be sent to the entropy coding unit 108 to be compressed and/or packed to form the bit-stream.

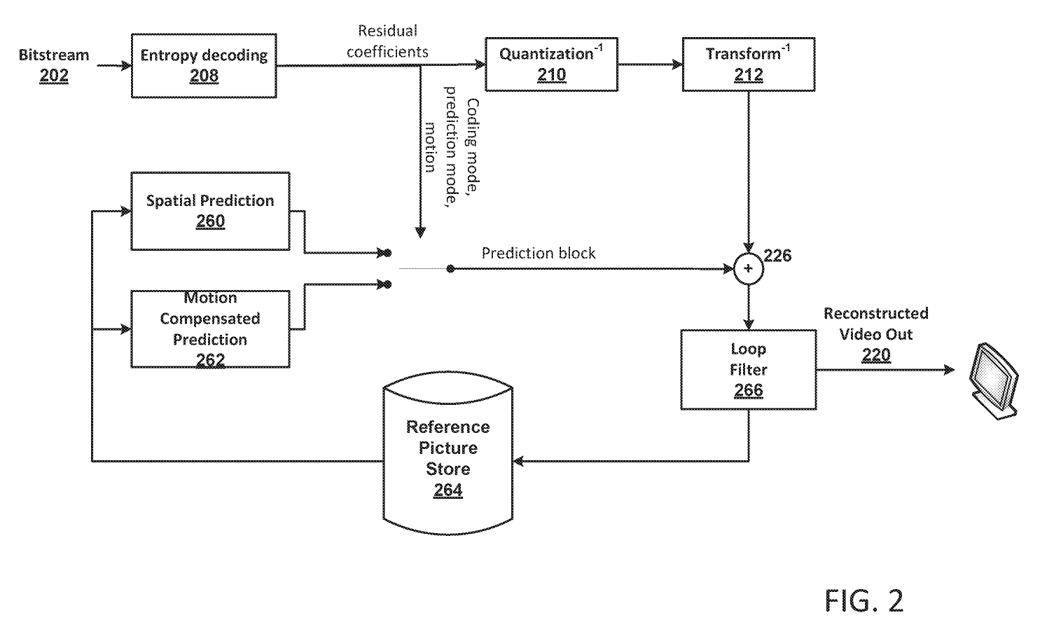

FIG. 2 is an example general block diagram of a block based video coding device. FIG. 1 may illustrate, for example, a block-based video decoder. The video bit-stream 202 may be unpacked and/or entropy decoded at the entropy decoding unit 208. The coding mode and/or prediction information may be sent to the spatial prediction unit 260 (e.g., if intra coded) and/or the temporal prediction unit 262 (e.g., if inter coded), for example, to form a prediction block. The residual transform coefficients may be sent to the inverse quantization unit 210 and/or inverse transform unit 212, for example, to reconstruct the residual block. The prediction block and/or the residual block may be added together at 226. The reconstructed block may go through in-loop filtering, e.g., before it is stored in reference picture store 264. A reconstructed video 220 in reference picture store may be sent to drive a display device and/or used to predict future video blocks.

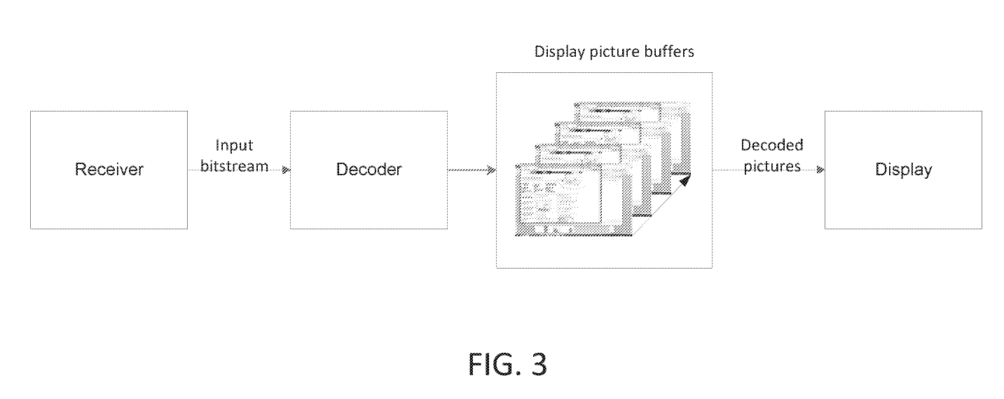

Screen content compression may be utilized more, for example, because people share their device content for media presentation or remote desktop purposes. The screen display of mobile devices may be high definition or ultra-high definition resolutions. Video coding tools, such as block coding modes and transform, may not be optimized for screen content encoding because they may increase the bandwidth requirements for transmitting screen content in those sharing applications. FIG. 3 illustrates an example block diagram of a screen content sharing system. The screen content sharing system of FIG. 3 may comprise a receiver, a decoder, and display (e.g., renderer). FIG. 1 illustrates an example block diagram of a block-based single layer video cording device (e.g., video encoding device). As shown in FIG. 1, to achieve efficient compression, the video coding device (e.g., video encoding device) may employ techniques, such as spatial prediction (e.g., intra prediction) and temporal prediction (e.g., inter prediction and/or motion compensated prediction) to predict an input video signal. The video coding device (e.g., the video encoding device) may have mode decision logics that may determine a suitable (e.g., the most suitable) form of prediction, for example, based on certain criteria such as a combination of rate and distortion. The video cording device (e.g., video encoding device) may transform and quantize the prediction residual (e.g., the difference between the input signal and the prediction signal). The quantized residual, together with mode information (e.g., intra or inter prediction) and prediction information (e.g., motion vectors, reference picture indexes, intra prediction modes, etc.) may be compressed at the entropy coder and/or packed into the output video bit-stream. As may be shown in FIG. 1, the video cording device (e.g., video encoding device) may generate the reconstructed video signal, for example, by applying inverse quantization and/or inverse transform to the quantized residual to obtain reconstructed residual. The video cording device (e.g., video encoding device) may generate the reconstructed video signal, for example, by adding the reconstructed residual back to the prediction signal. The reconstructed video signal may go through loop filter processes (e.g., de-blocking filter, sample adaptive offsets). The reconstructed video signal may be stored in the reference picture store for predicting future video signal.

FIG. 2 illustrates a block diagram of a block-based single layer video coding device (e.g., video decoding device). The video coding device (e.g., video decoding device) in FIG. 2 may receive the bit-stream produced by the video coding device (e.g., video encoding device) in FIG. 1 and reconstruct the video signal to be displayed. At the decoder, the bit-stream may be parsed by the entropy decoder. The residual coefficients may be inverse quantized and/or inverse transformed to obtain the reconstructed residual. The coding mode and/or prediction information may be used to obtain the prediction signal, for example, using either a spatial prediction or temporal prediction. The prediction signal and the reconstructed residual may be added together to get the reconstructed video. The reconstructed video may go through loop filtering, for example, before being stored in the reference picture store to be displayed and/or to be used to decode future video signal.

MPEG has been working on video coding standards, for example, to save transmission bandwidth and storage. High Efficiency Video Coding (HEVC) is a video compression standard. HEVC was jointly developed by the ITU-T Video Coding Experts Group (VCEG) and the ISO/IEC Moving Picture Experts Group (MPEG) together. HEVC may save 50% bandwidth compared to H.264 with the same quality. HEVC may be a block based hybrid video coding standard such that its encoder and decoder generally operate according to FIG. 1 and/or FIG. 2. HEVC may allow the use of larger video blocks than the video bocks under other standards. HEVC may use quad-tree partition to signal block coding information. The picture or slice may be partitioned into coding tree blocks (CTB) with same or similar sizes (e.g., 64×64). One or more (e.g., each) CTB may be partitioned into CUs with quad-tree, and one or more (e.g., each) CU may be partitioned into prediction units (PU) and/or transform units (TU) with the quad-tree. Depending on the precision of motion vectors (e.g., which can be up to quarter pixel in HEVC), linear filters may be applied to obtain pixel values at fractional positions. In HEVC, the interpolation filters may have 7 or 8 taps for luma and 4 taps for chroma. A de-blocking filter in HEVC may be content-based. Different dc-blocking filter operations may be applied at the TU and PU boundaries, depending on a number of factors, such as coding mode difference, motion difference, reference picture difference, pixel value difference, etc. For entropy coding, HEVC may utilize a context-based adaptive arithmetic binary coding (CABAC) for one or more block level syntax elements. High level parameters may or may not be used. There may be various kinds (e.g., two kinds) of bins in the CABAC: context-based coded regular bins, and/or by-pass coded bins without context.

Video coding designs may comprise various block coding modes. Spatial redundancy in video data or signal data or content data may be utilized for screen content coding. Camera-captured nature content may comprise continuous-tone video signal. Screen content may be comprise discrete-tone video signal. Since screen content material, such as text and graphics, may show different characteristics compared to natural content, coding tools, such as intra block copy, palette coding, and adaptive color transform, may be utilized for screen content coding.

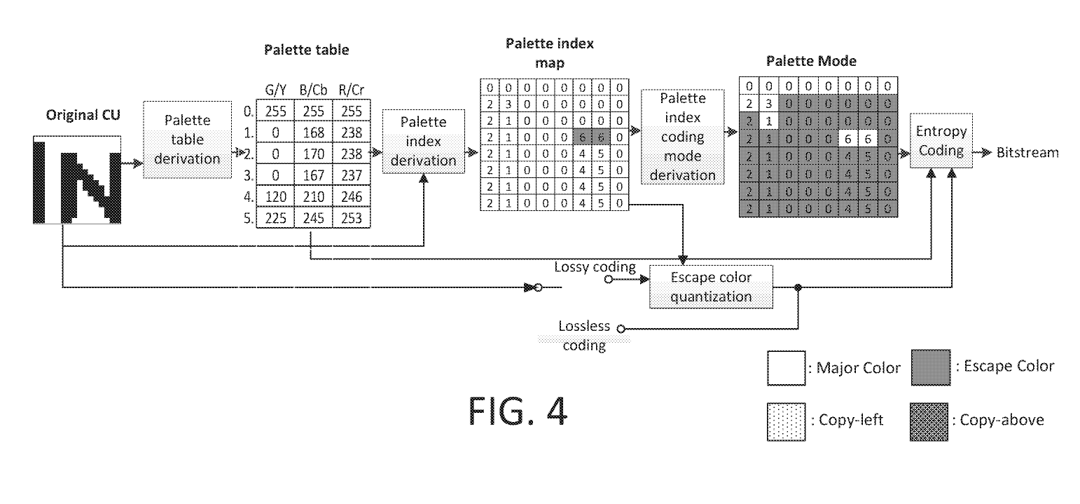

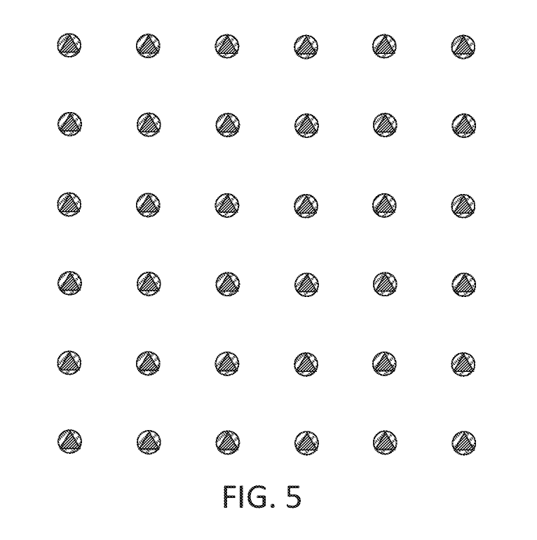

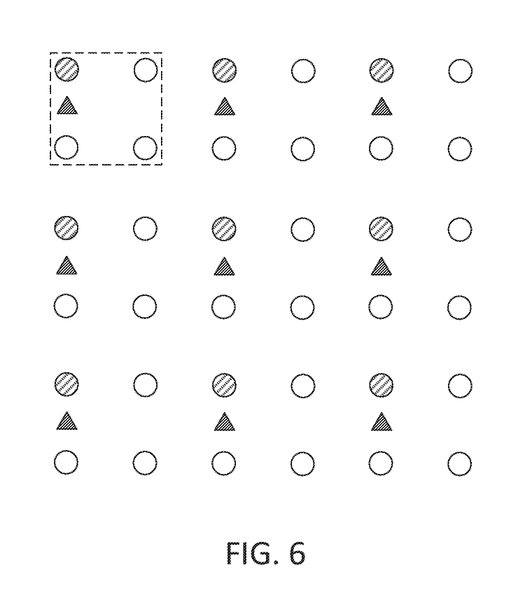

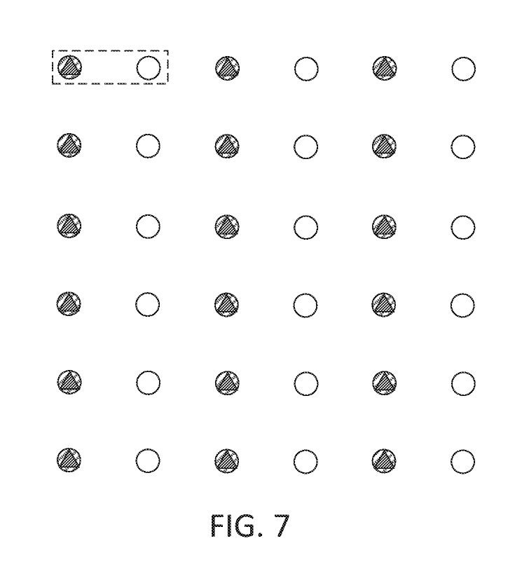

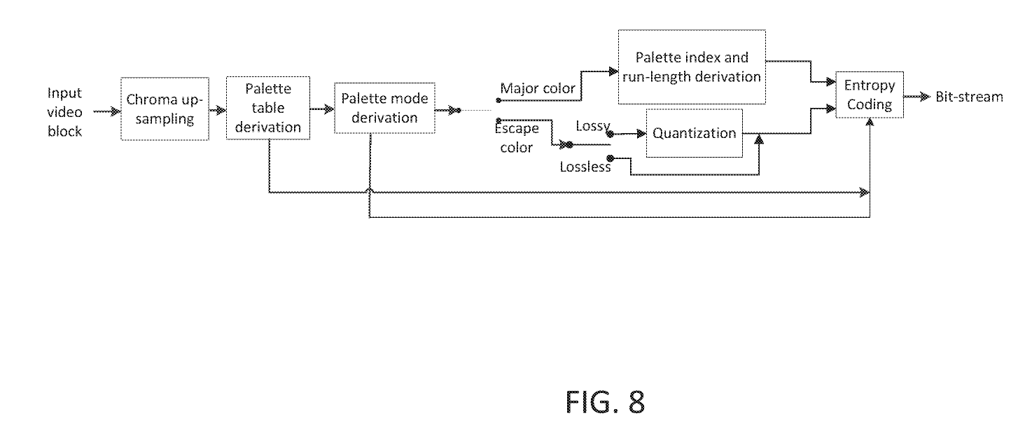

Palette-based coding may be used in recursive quad-tree framework of HEVC, for example, to code screen content by considering characteristics. FIG. 4 illustrates an example block diagram of a video coding process of palette-based coding. As shown in FIG. 4, video blocks in screen content video may comprise (e.g., be dominated by) a limit number of major colors, and the color value of one or more pixels may be the same as or similar to that of its above or left pixel. A color table and index map representing the major colors and the escape colors of the video block may be utilized for the coding of that block, for example, instead of using the sample values of all the pixels. FIG. 5 illustrates an example sampling grid of luma and chroma components in a 4:4:4 format. FIG. 6 illustrates an example sampling grid of luma and chroma components in a 4:2:0 format. FIG. 7 illustrates an example sampling grid of luma and chroma components in a 4:2:2 format. FIG. 8 illustrates an example block diagram of the encoding process of palette coding for non-4:4:4 videos. For example, in FIG. 4, for one or more (e.g., each) coding unit (CU) coded with a palette mode, a palette table may be derived by selecting a set of major colors from that CU. A palette index map may be generated by classifying the pixels of the CU into major colors and escape colors. The escape colors may be marked as void blocks in FIG. 4. The major colors may be marked as patterned blocks in FIG. 4. For the pixels whose colors are represented in the palette table, the indices (e.g., only the indices) in the palette table may be encoded. For the pixels whose colors are not represented in the palette table, their color values may be considered as escape colors. Quantized color values (e.g., if lossy coding is used) may be directly encoded. Various (e.g., two) predictive coding modes, such as a copy-left mode and a copy-above mode, may be utilized to encode the palette index map. In the copy-left mode, the value of one palette index and a run value may be signaled. The run value may indicate the number of the subsequent pixels that have the same palette index as the current pixel. In the copy-above mode, the palette indices of the coded pixels may be copied from the neighboring pixels directly above them. The run value may be signaled to indicate the number of subsequent pixels that copy their palette indices from the corresponding above neighbors. For example, the run value may only be signaled to indicate the number of subsequent pixels that copy their palette indices from the corresponding above neighbors. If the palette table size is K, the palette indices 0 to K−1 may be used to indicate major colors, and the palette index K may be used to indicate escape colors. Table 1 illustrates an example palette mode syntax.

TABLE 1
Example Palette Mode Syntax

| palette_coding( x0, y0, nCbS ) { | Descriptor |
|---|---|
| palette_transpose_flag | ae(v) |
| palette_share_flag[ x0 ][ y0 ] | ae(v) |
| if( palette_share_flag[ x0 ][ y0 ] ) { | |
| palette_size = previousPaletteSize | |
| for( n = 0; n < palette_size: n++ ) | |
| for( cIdx = 0; cIdx < 3; cIdx++ ) | |
| palette_entries[ cIdx ][ n ] = previousPaletteEntries[ cIdx ][ n ] | |
| } else { | |
| numPredPreviousPalette = 0 | |
| for( i = 0; i < previousPaletteStuffingSize; i++ ) | |
| previous_palette_entry_flag[ i ] = 0 | |
| palette_last_group = 0 | |
| for( i = 0; i < previousPaletteStuffingSize && !palette_last_group && | |
| numPredPreviousPalette < max_palette_size: i++ ) | |
| lastPossibleGroupFlag = ( i + 4 >= previousPaletteStuffingSize ) | |
| lastIdx = min( i + 4, previousPaletteStuffingSize ) − 1 | |
| if( i > 3 && !lastPossibleGroupFlag ) | |
| palette_all_zeros_in_group | ae(v) |
| Else | |
| palette_all_zeros_in_group = 0 | |
| if( palette_all_zeros_in_group ) | |
| i += 4 | |
| else { | |
| numOnesInGroup = 0 | |
| for( idx = i; idx <= lastIdx && numPredPreviousPalette < | |
| max_palette_size; | |
| idx++ ) { | |
| if ( idx == lastIdx && numOnesInGroup == 0 ) | |
| previous_palette_entry_flag[ idx ] = 1 | |
| Else | |
| previous_palette_entry_flag[ idx ] | ae(v) |
| if ( previous_palette_entry_flag[ idx ] ) { | |
| for ( cIdx = 0; cIdx < 3; cIdx++ ) | |
| palette_entries[ cIdx ][ numPredPreviousPalette ] = | |
| previousPaletteEntries[ cIdx ][ idx ] | |
| numPredPreviousPalette++ | |
| numOnesInGroup++ | |
| } | |
| } | |
| if( !palette_all_zeros_in_group && | |
| !lastPossibleGroupFlag && numPredPreviousPalette < | |
| max_palette_size ) | |
| palette_last_group | ae(v) |
| } | |
| } | |
| if( numPredPreviousPalette < max_palette_size) | |
| num_signalled_palette_entries | ae(v) |
| for( cIdx = 0; cIdx < 3; cIdx++ ) | |
| for( i = 0; i < num_signalled_palette_entries; i++ ) | |
| palette_entries[ cIdx ][ numPredPreviousPalette + i ] | ae(v) |
| palette_size = numPredPreviousPalette + num_signalled_palette_entries | |
| } | |
| palette_escape_val_present_flag | ae(v) |
| if( palette_escape_val_present_flag ) | |
| indexMax = palette_size | |
| Else | |
| indexMax = palette_size − 1 | |
| scanPos = 0 | |
| while( scanPos < nCbS * nCbS ) { | |
| xC = x0 + travScan[ scanPos ][ 0 ] | |
| yC = y0 + travScan[ scanPos ][ 1 ] | |
| if( scanPos > 0) { | |
| xC_prev = x0 + travScan[ scanPos − 1 ][ 0 ] | |
| yC_prev = y0 + travScan[ scanPos − 1 ][ 1 ] | |
| } | |
| if( scanPos >= nCbS && palette_mode[xC_prev][yC_prev] ! = | |
| COPY_ABOVE ) | |
| palette_mode[ xC ][ yC ] | ae(v) |
| if( palette_mode[ xC ][ yC ] ! = COPY_ABOVE ) { | |
| adjustedIndexMax = indexMax | |
| adjustedRefIndex = indexMax + 1 | |
| } | |
| if( scanPos > 0 && palette_mode[xC_prev][yC_prev] ! = ESCAPE ) { | |
| if( palette_mode[xC_prev][yC_prev] == INDEX ) { | |
| adjustedIndexMax −= 1 | |
| adjustedRefIndex = paletteMap[ xC_prev ][ yC_prev ] | |
| } | |
| if( scanPos >= nCbS && palette_mode[ xC_prev ][ yC_prev ] == | |
| COPY_ABOVE | |
| && palette_mode[ xC ][ yC − 1 ] ! = ESCAPE ) { | |
| adjustedIndexMax −= 1 | |
| adjustedRefIndex = paletleMap[ xC ][ yC − 1 ] | |
| } | |
| } | |
| if( palette_mode[ xC ][ yC ] ! = COPY_ABOVE ) { | |
| if( adjustedIndexMax > 0 ) | |
| palette_index | ae(v) |
| if( palette_index >= adjustedRefIndex ) | |
| palette_index++ | |
| if( palette_index == palette_size ) { | |
| for( cIdx = 0; cIdx < 3; cIdx++ ) { | |
| palette_escape_val | ae(v) |
| paletteEscapeVal[ cIdx ][ xC ][ yC ] = palette_escape_val | |
| } | |
| palette_mode[ xC ][ yC ] = ESCAPE | |
| scanPos++ | |
| } | |
| } | |
| if( palette_mode[xC][yC] ! = ESCAPE ) { | |
| palette_run | ae(v) |
| runPos = 0 | |
| runMode = palette_mode[ xC ][ yC ] | |
| while ( runPos <= palette_run ) { | |
| xC = x0 + travScan[ scanPos ][ 0 ] | |
| yC = y0 + travScan[ scanPos ][ 1 ] | |
| if( palette_mode[ xC ][ yC ] == INDEX ) { | |
| palette_mode[ xC ][ yC ] = INDEX | |
| paletteMap[ xC ][ yC ] = palette_index | |
| } else { | |
| palette_mode[ xC ][ yC ] = COPY_ABOVE | |
| paletteMap[ xC ][ yC ] = paletteMap[ xC ][ y − 1 ] | |
| } | |
| runPos++ | |
| scanPos++ | |
| } | |
| } | |
| } | |
| previousPaletteSize = palette_size | |
| current_size = palette_size | |
| for( i = 0; i < palette_size; i++ ) | |
| for ( cIdx = 0; cIdx < 3; cIdx++ ) | |
| tempPaletteEntries[ cIdx ][ i ] = palette_entries[ cIdx ][ i ] | |
| for( i = 0; i < previousPaletteStuffingSize && current_size < | |
| max_palette_predictor_size; | |
| i++ ) | |
| if( previous_palette_entry_flag[ i ] == 0 ) { | |
| for ( cIdx = 0; cIdx < 3; cIdx++ ) | |
| tempPaletteEntries[ cIdx ][ current_size ] = | |
| previousPaletteEntries[ cIdx ][ i ] | |
| current_size++ | |
| } | |
| previousPaletteStuffingSize = current_size | |
| previousPaletteEntries = tempPaletteEntries | |
| } | |

A color clustering may be used to derive the palette table for one or more (e.g., each) CU coded with the palette mode. The color values of the current CU may be clustered into K sets K may be the size of the palette table. The original color values in the current CU may be denoted as c={c_0, c_1, . . . c_(N−1)}. One or more (e.g., each) color value c_i may be a three-dimensional vector N may be the total number of pixels in the CU. The color clustering operation may aim to partition the colors of the N pixels into K (K:N) sets. S may be the color sets. S={S_0, S_1, . . . S_(K−1)}. For example, formula (1) may be used to minimize the within-cluster distortion:

$${arg min}_{S} {\sum }_{i = 0}^{K - 1} {\sum }_{c ∈ {S}_{i}} {\sum }_{h = 0}^{2} ‖ {c}^{h} - {μ}_{i}^{h} ‖ \qquad ( 1 )$$

μᵢ^{h} may be the h-th component (e.g., Y, Cb and Cr) of the centroid of the color set Sᵢ. The centroids of the color clusters may be used as the major colors to form the palette table of the current CU. The palette table may be derived. For one or more (e.g., each) pixel c, a palette index i⁺ may be selected by converting the color values of the pixel into a major color in the palette table. For example, formula (2) may be used to calculate i⁺. The distortion between the pixel and the selected major color may be minimized by using Formula (2):

$${i}^{*} = {arg min}_{i} {\sum }_{h = 0}^{2} ‖ {c}^{h} - {μ}_{i}^{h} ‖ \qquad ( 2 )$$

A video coding system may devote more bandwidth to the luma component (e.g., Y component in YCbCr format) than to the chroma components (e.g., Cb and Cr components in YCbCr format). The video coding system may subsample the chroma components. Subsampling the chroma components may or may not degrade the perceived quality for the reconstructed video because human visions are more sensitive to variations in brightness than color. 4:4:4 (e.g., FIG. 5), 4:2:2 (e.g., FIG. 7) and 4:2:0 (e.g., FIG. 6) are example chroma subsampling formats that may be used in video coding systems. FIG. 5, FIG. 7, and FIG. 6 are examples of 4:4:4, 4:2:2, and 4:2:0 chroma subsampling formats, respectively. In FIG. 6, the sampling rates of the chroma components in both horizontal and vertical directions may be half of the sampling rate of the luma component. In FIG. 7, the horizontal sampling rate of the chroma components may be half of the sampling rate of the luma component. The vertical sampling rate may be the same as the sampling rate of the luma component. 4:4:4 chroma format may be used for video applications that require high fidelity. In FIG. 5, the sampling rates of the chroma components in both horizontal and vertical directions may be the same as the sampling rate of the luma component. The sampling grids of chroma formats as shown in FIG. 5, FIG. 6, and FIG. 7 may be illustrative. Variants of relative phase shifts between the luma sampling grid and the chroma sampling grid may be used. For example, sampling grids with various relative phase shifts between luma and chroma components may be used in 4:2:0 subsampling. Cb and Cr components may be subsampled halfway between corresponding neighboring luma samples in the horizontal direction only, in the vertical direction only, or in both directions.

The palette mode may be used for coding video signals in the 4:4:4 chroma format and in non-4:4:4 chroma formats, such as 4:2:0 and 4:2:2 formats. Non-4:4:4 chroma formats may be utilized in applications for screen content, such as hyperspectral imaging, medical and remote sensing, etc. Video devices may or may not support videos in the 4:4:4 chroma format, e.g., due to 4:4:4 chroma format's complexity/bandwidth constraints. Coding tools may be used to support coding video materials in non-4:4:4 chroma formats, such as 4:2:0 and 4:2:2 formats.

The palette mode may be used to code screen content videos that are in non-4:4:4 chroma formats. Palette coding may be utilized for non-4:4:4 screen content videos. Examples described herein may be applied to any video codecs.

Although the techniques and examples described herein are described with respect to 4:2:0 and 4:2:2 chroma formats, those skilled in the art would appreciate that the techniques and examples described herein apply equally to other non-4:4:4 chroma formats, such as 4:0:0, 4:2:1, 4:1:1 and 4:1:0, etc.

Some palette coding implementations may support the input videos with 4:4:4 chroma formats. The palette mode may be disabled for non-444 input videos. Screen content materials may be captured in non-4:4:4 chroma formats. The tools developed for the 4:4:4 chroma format may be supported and/or tested for 4:2:0 and 4:2:2 chroma formats.

The palette mode may be enabled for videos in non-4:4:4 chroma formats. Dual-palette based palette coding may be utilized for screen content videos in 4:2:0 and 4:2:2 chroma formats, e.g., for efficiency. In dual-palette based palette coding, one or more (e.g., two) palette tables may be used, one for the luma component and the other for the two chroma components. For example, colors (e.g., the most representative colors) from the current CU may be selected based on color histograms. The color histograms may be calculated separately for luma and chroma components. One or more (e.g., two) palette index maps may be formed for the luma component and the chroma components, e.g., one for luma component and the other for chroma component respectively. For example, the luma component and the chroma components of one or more (e.g., each) pixels in the current CU may be mapped into two separate palette indices, e.g., one for luma component and the other for chroma components. The copy-left mode and copy-above mode, as illustrated in FIG. 4, may be used to encode palette index maps (e.g., the two palette index maps). The dual-palette based implementation may provide additional coding gains.

When the dual-palette based implementation is used, separate (e.g., two) palette tables and/or separate (e.g., two) palette index maps may be sent for luma component and chroma components. The palette tables and the palette index maps may be derived separately for luma component and chroma components. The number of chroma samples may be smaller than the number of luma samples for videos in 4:2:0 and 4:2:2 chroma formats. An encoder may separately encode two sets of palette syntax elements for luma and chroma components. A decoder may separately parse two sets of palette syntax elements for luma and chroma components.

When the dual-palette based implementation is used, the decoder may perform one or more (e.g., two) separate palette decoding processes to reconstruct the luma samples and the chroma samples. The decoder may decode the Y component (e.g., only the Y component) in a luma palette decoding process. The decoder may decode the Cb and Cr components in a chroma palette decoding process. The decoder may perform the one or more (e.g., two) decoding processes on the samples with different dimensions. For example, the chroma block size may be one quarter of the luma block size for videos in the 4:2:0 chroma format. The chroma block size may be one half of the luma block size for videos in the 4:2:2 chroma format. The decoder may maintain one or more (e.g., two) separate palette tables and one or more (e.g., two) separate palette predictors when the dual-palette based implementation is used. A palette design for the 4:4:4 chroma format may differ from the dual-palette based implementation. The palette design for the 4:4:4 chroma format may utilize (e.g., only utilize) a (e.g., a single) palette table and/or a (e.g., a single) palette predictor for a CU.

The palette design for 4:4:4 chroma format may be extended to support 4:2:0 and 4:2:2 formats. For example, non-4:4:4 video may be coded via palette coding using the palette design for the 4:4:4 format.

Palette coding may be utilized for videos in non-4:4:4 chroma formats. The palette coding may use a same or similar syntax as the palette design associated with the videos in 4:4:4 chroma formats (e.g., as described in Table 1).

FIG. 8 illustrates an example block diagram of an encoding process of the palette coding for videos in non-4:4:4 chroma formats. As may be used herein, a pixel may include a single element (e.g., a sample) that comprises one or more components (e.g., one luma component and two chroma components) at the same position in 4:4:4 chroma format. A sample may refer to a single color component that may be either the luma component or one of the two chroma components for videos in 4:2:0 and 4:2:2 chroma formats. A sample and a sample position may be used interchangeably. The chroma sample and the luma sample may be located at different pixel positions in the 4:2:0 and 4:2:2 chroma formats, e.g., due to chroma subsampling. As shown in FIG. 8, the palette implementation for videos in non-4:4:4 chroma formats may process the luma and chroma components of the input video at higher spatial resolution (e.g., the luma resolution). The palette implementation for videos in non-4:4:4 chroma formats may produce the bit-stream for palette-coded CUs in a similar manner as the palette encoder may do for videos in 4:4:4 chroma formats in FIG. 4. Chroma up-sampling may be utilized to up-sample the chroma components to the same or similar resolution as the resolution of the luma component. The input video block may become a 4:4:4 block. Palette encoding logics for the input video block may be reused. To up-sample the resolution of chroma components to that of the luma component, different examples may be used to generate the chroma samples at one or more (e.g., each) pixel positions in the 4:4:4 chroma format. For a given luma sample position, the chroma sample at the position near (e.g., closest in phase distance to) the luma sample position may be used. For example, the nearest neighbor copy may be applied.

For one or more (e.g., each) luma sample location in the 4:4:4 chroma format, an interpolation-based upsampling process may be used to generate the corresponding chroma samples. For example, the following interpolation method may be used:

$${c}^{*} = \frac{{\sum }_{{C}_{i ∈ N}} ( {s}_{i} \cdot {c}_{i} )}{{\sum }_{{C}_{i ∈ N}} {s}_{i}} \qquad ( 3 )$$

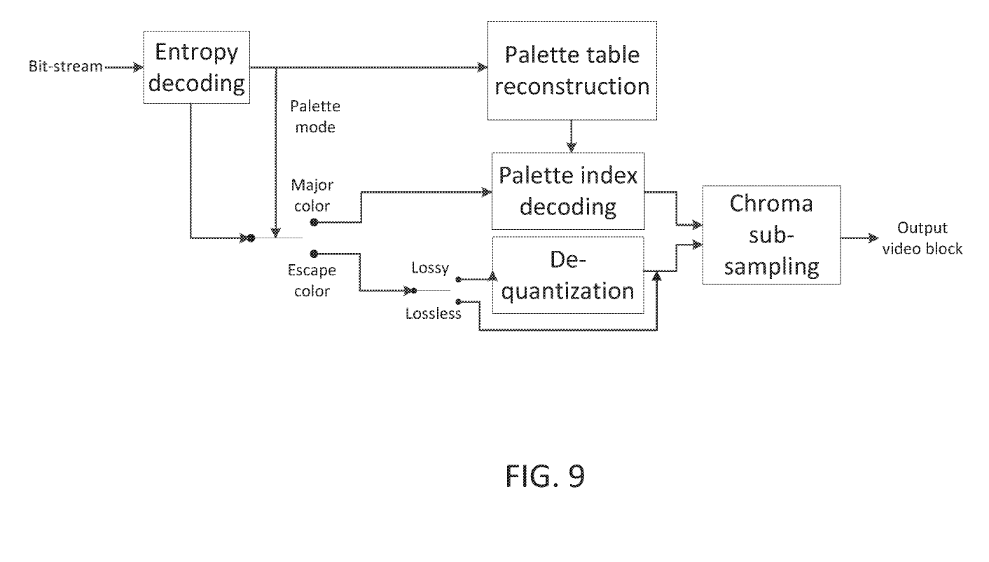

c* may be the up-sampled chroma component. N may be the set of chroma samples that may be near (e.g., neighboring to) the target pixel position. cᵢ may be the value of the i-th chroma sample used in the interpolation. sᵢ may be weighting factor that may be applied to the i-th chroma sample. Different metrics may be used to derive sᵢ. For example, sᵢ may be derived according to the phase distance between the luma sample and the chroma sample. Interpolation filters may be used to map the chroma and luma samples to the same pixel positions. The same interpolation filters may be used in non-4:4:4 palette coding. FIG. 9 illustrates an example block diagram of the decoding process of palette coding for videos in non-4:4:4 chroma format.

FIG. 9 may correspond to the encoding process in FIG. 8. The decoder may reconstruct an intermediate block in 4:4:4 format using the received palette table, the palette indices, and the identified escape colors. The bit-stream of the current CU may be entropy decoded using an entropy decoding module. The palette table information may be sent to a palette table reconstruction module to form a palette table containing the major colors of the current CU. The palette coding information (e.g., palette indices and run lengths) and the quantized (e.g., if lossy coding is applied) escape colors may be sent to the palette index decoding module, if a pixel is coded as a major color. The palette coding information (e.g., palette indices and run lengths) and quantized (e.g., if lossy coding is applied) escape colors may be sent to a de-quantization module (e.g., if lossy coding is applied), to reconstruct the color components of one or more (e.g., each) pixel position of the intermediate block in 4:4:4 format if the pixel is coded as escape color. A chroma sub-sampling module may be used to reconstruct the video block with different resolutions of the luma and chroma components, as shown in an example in FIG. 9.

A decoder may determine the chroma sample values (e.g., the Cb and Cr component sample values) of a pixel position from a plurality of neighboring pixel positions when the chroma sub-sampling is used. The decoder may reconstruct the chroma sample values of the CU from the chroma sample values of the pixel positions. A plurality of neighboring pixel positions may be referred to as a pixel set. Pixel positions in the pixel set may be selected based on the sampling rate ratio between the 4:4:4 chroma resolution and the 4:2:0 or 4:2:2 chroma resolution. For example, as shown in FIG. 5, FIG. 6 and FIG. 7, one pixel set (e.g., as enclosed by dash-line rectangles) may comprise a 2×2 block of pixel positions for the 4:2:0 chroma format and a 1×2 block of pixel positions for the 4:2:2 chroma format. For one or more (e.g., each) pixel set in FIG. 5, FIG. 6 and FIG. 7, the patterned pixels may be the pixel positions for which the luma sample and the chroma samples have values. The non-pattern pixels may be the pixel positions for which only the luma sample has value. In an example of the chroma sub-sampling process for reconstructing the output CU in the 4:2:0 or 4:2:2 chroma format, the chroma samples in the intermediate 4:4:4 block located at the patterned pixel positions may be kept. The chroma samples in the intermediate 4:4:4 block located at the non-patterned pixel positions may be discarded. In FIG. 5, FIG. 6 and FIG. 7, the patterned pixels may be located at the top-left or the top of each pixel set. FIG. 5. FIG. 6 and FIG. 7 are examples of the arrangement. Other arrangements may be used. For example, the patterned pixels may be located at the bottom-left or the bottom of each pixel set. A pixel (e.g., other than the top-left or the top pixel in FIG. 5, FIG. 6 and FIG. 7) in a pixel set may be selected as the pixel position whose corresponding chroma samples may be retained in the final output 4:2:0 or 4:2:2 video block.

In the chroma sub-sampling process, an interpolation-based sub-sampling process may be used to sub-sample the chroma components from the intermediate 4:4:4 block to the output non-4:4:4 video block as shown in Formula (4):

$${c}^{+} = \frac{{\sum }_{{u}_{i ∈ B}} ( {h}_{i} \cdot {u}_{i} )}{{\sum }_{{u}_{i ∈ B}} {h}_{i}} \qquad ( 4 )$$

c⁺ may be the sub-sampled chroma components. B may be the pixel set that represents the plurality of neighboring pixels of the target chroma sample. uᵢ may be the sample value of the chroma component of the i-th pixel in the pixel set B. hᵢ may be the weighting factor that may be applied to uᵢ. Different metrics may be used to derive hᵢ. For example, hᵢ may be derived according to the phase distance between the luma sample and the chroma sample.

A video bit-stream for a video in a non-4:4:4 chroma format may be decoded in palette mode. Inputs to the decoding process for the palette mode for non-4:4:4 format may include a location (xCb, yCb) specifying the top-left sample of the current block relative to the top-left sample of the current picture; a variable cIdx specifying the color component of the current block; a variable nCbS specifying the size of the current block; an array palette_mode[xCb+x][yCb+y], with x=0 . . . nCbS−1 and y=0 . . . nCbS−1, specifying the palette mode for one or more (e.g., each) samples in the current block; the array paletteMap[xCb+x][yCb+y], with x=0 . . . nCbS−1, y=0 . . . nCbS−1, specifying the palette index for one or more (e.g., each) samples in the current block for which the palette mode may be unequal to ESCAPE; and/or the array palette_escape_val[xCb+x][yCb+y], with x=0 . . . nCbS−1 and y=0 . . . nCbS−1, specifying the quantized escape value for one or more (e.g., each) sample in the current block for which the palette mode may be equal to ESCAPE; etc.

Depending on the value of the color component cIdx, the variable nSubWidth and nSubHeight may be derived. If cIdx is equal to 0 (e.g., the sample may be a luma sample), nSubWidth may be set to 1 and nSubHeight may be set to 1. If cIdx is not equal to 0 (e.g., the sample may be a chroma sample), nSubWidth may be set to SubWidthC and nSubHeight may be set to SubHeightC. The output may be array recSamples[x][y], with x=0 . . . nCbS/nSubWidth−1, y=0 . . . nCbS/nSubHeight−1, specifying reconstructed sample values for the palette block.

Depending on the value of the color component cIdx, the following assignments may be made. If cIdx is equal to 0, recSamples may correspond to the reconstructed picture sample array S_{L} and the function clipCidx1 may correspond to Clip1_{Y}. If cIdx is equal to 1, recSamples may correspond to the reconstructed chroma sample array S_{Cb} and the function clipCidx1 may correspond to Clip1_{C}. If cIdx is equal to 2, recSamples may correspond to the reconstructed chroma sample array S_{Cr} and the function clipCidx1 may correspond to Clip1_{C}.

The video decoding device may receive one or more CUs in the non 4:4:4 chroma format. For example, the bit-stream may include data defining a palette table and a palette index map in the 4:4:4 chroma format for the current block. For a luma sample position in the non-4:4:4 chroma format, a respective luma sample value may be determined based on the luma sample position, the palette index map, and the palette table. A color index value associated with the luma sample position may be determined, and used to look up the respective luma sample value in the palette table.

The video decoding device may sub-sample the CU in the 4:4:4 chroma format to obtain a CU in the non-4:4:4 chroma format. For a chroma sample position in the non 4:4:4 chroma format, a chroma sample position associated with the 4:4:4 chroma format on the palette index map may be derived based on the resolution ratio of the luma component to the chroma components in the non-4:4:4 chroma format. For a chroma sample position in the 4:4:4 chroma format, a chroma sample position associated with the non-4:4:4 chroma format on the palette index map may be derived based on the resolution ratio(s) of the chroma components in the 4:4:4 chroma format to the chroma components in the non-4:4:4 chroma format. For a chroma component of one or more CUs in the non-4:4:4 chroma format, the video coding device may locate the corresponding chroma components in the 4:4:4 chroma format. The video decoding device may map a position in the 4:4:4 chroma format coordinates to the corresponding position in the non-4:4:4 format coordinates. For example, chroma format coordinates may be calculated based on the variables nSubWidth and nSubHeight. Parameter nSubWidth may indicate the ratio of the horizontal resolution of the chroma components in the 4:4:4 chroma format to the horizontal resolution of the chroma components of the non-4:4:4 chroma format. Parameter nSubHeight may indicate the ratio of the vertical resolution of the chroma components in the 4:4:4 chroma format to the vertical resolution of the non-4:4:4 chroma format. A video decoding device may determine the variables nSubWidth and nSubHeight from the bit-stream. A respective chroma sample value for the chroma sample position in the non-4:4:4 chroma format may be determined based on the derived chroma sample position associated with the 4:4:4 chroma format, the palette index map and the palette table.

The (nCbS/nSubWidth×nCbS/nSubHeight) block of the reconstructed sample array recSamples at the location (xCb/nSubWidth, yCb/nSubHeight) may be derived. For x=0 . . . nCbS/nSubWidth−1, y=0 . . . nCbS/nSubHeight SubHeightC−1, recSample[cIdx][yCb/nSubHeight SubHeightC+y][xCb/nSubWidth+x] may be set. If palette_mode[xCb+x*nSubWidth][yCb+y*nSubHeight] is not equal to ESCAPE, the following may applies. If palette_transpose_flag is true, the following may apply: recSample[cIdx][yCb/nSubHeight+y][xCb/nSubWidth+x]=palette_entries[cIdx][paletteMap[xCb+x*nSubWidth][yCb+y*nSubHeight]]. If palette_transpose_flag is false, the following may apply: recSample[cIdx][xCb/nSubWidth+x][yCb/nSubHeight+y]=palette_entries[cIdx][paletteMap[xCb+x*nSubWidth][yCb+y*nSubHeight]]. If cu_transquant_bypass_flag is true, the following may apply. If palette_transpose_flag is true, the following may apply: recSample[cIdx][yCb/nSubHeight+y][xCb/nSubWidth+x]=palette_escape_val[cIdx][xCb+x*nSubWidth][yCb+y*nSubHeight]. If palette_transpose_flag is false, the following may apply: recSample[cIdx][xCb/nSubWidth+x][yCb/nSubHeight+y]=palette_escape_val[cIdx][xCb+x*nSubWidth][yCb+y*nSubHeight]. If palette_model[xCb+x*nSubWidth][yCb+y*nSubHeight] is equal to ESCAPE and cu_transquant_bypass_flag is false, the following steps may apply. The derivation of quantization parameters as may be described herein may be invoked, for example, if the current block is the first block in the slice, availableA is equal to FALSE, availableB is equal to FALSE, and CuQpDeltaVal is equal to 0. The quantization parameter qP may be derived as follow: if cIdx is equal to 0, qP may be set to Qp′_{Y}; if cIdx is equal to 1, qP may be set to Qp′_{Cb}; if cIdx is equal to 2, qP may be set to Qp′_{Cr}. The variable bdShift may be derived as follows:

bitShift=((cIdx==0)?BitDepth_{Y}:BitDepth_{C})+Log 2(nTbS)−5 (5)

The list levelScale[ ] may be specified as levelScale[k]={40, 45, 51, 57, 64, 72} with k=0.5. The following may apply. If palette_transpose_flag is true, the following may apply:

recSamples[xCb/nSubWidth+x][yCb/nSubHeight+y]=Clip3(0.1<<bdShift−1,((palette_escape_val[cIdx][yCb+y*nSubHeight][xCb+x*nSubWidth]*16*levelScale[qP%6]<<(qP/6))+(1<<(bdShift−1)))>>bdShift)

If palette_transpose_flag is false, the following may apply:

recSamples[xCb/nSubWidth+x][yCb/nSubHeight+y]=Clip3(0,1<<bdShift−1,((palette_escape_val[cIdx][xCb+x*nSubWidth][yCb+y*nSubHeight]*16*levelScale[qP%6]<<(qP/6))+(1<<(bdShift−1)))>>bdShift)

Syntax redundancy removal for escape colors may be described herein.

As shown in Table 1, if a pixel may be coded as an escape color, the sample values of the components may be quantized (e.g., if lossy coding is applied) and transmitted to the decoder through the syntax element palette_escape_val. For one or more (e.g., each) pixel sets, the chroma sample values of a pixel position may be used to reconstruct the output CU in the non-4:4:4 palette implementation. The chroma sample values of the other pixels in the same pixel set may or may not be signaled, for example, if those pixels are coded as escape colors. The pixel positions may be used to condition the presence of the syntax element palette_escape_val for chroma components, such that for escape color coded pixel positions, the chroma sample values that may be used in the reconstruction process may be signaled in the bit-stream.

When a pixel position is coded as an escape color the sample values of the color components may be quantized (e.g., if necessary) and coded if the pixel position corresponds to the patterned pixel position in one or more (e.g., each) pixel set. If the escape color pixel position corresponds to the remaining pixels (e.g., the non-patterned pixels) in the same pixel set, the luma sample value may be quantized (e.g., if necessary) and signaled in the bit-stream. Table 2 illustrates the syntax design based on the conditional inclusion of chroma components in escape color signaling.

TABLE 2
Example Palette Mode Syntax with the Conditional Inclusion
of Chroma Component in Escape Color Signaling

```
palette_coding( x0, y0, nCbS ) {
......
  scanPos = 0
  while( scanPos < nCbS * nCbS ) {
......
```

if( palette_mode[ xC ][ yC ] ! = COPY_ABOVE ) {
if( adjustedIndexMax > 0 )

palette_index

if( palette_index > = adjustedRefIndex )

palette_index++

if( palette_index = = palette_size ) {

for( cIdx = 0; cIdx < 3; cIdx++ ) {

if( ( cIdx == 0 ) ∥ ( ChromaArrayType == 1 &&

(xC&1 == 0) && (yC&1 == 0) )

∥ ( ChromaArrayType == 2 && (xC&1 == 0) ) ∥

ChromaArrayType == 3 ) {

```
  palette_escape_val
  paletteEscapeVal[ cIdx ][ xC ][ yC ] = palette_escape_val
```

}

}
palette_mode[ xC ][ yC ] = ESCAPE
scanPos++

}
}

......
}
......
}

A video coding device may be configured to code a pixel position as an escape color. A palette table may comprise a plurality of color values corresponding to a plurality of major colors in the CU. A palette index map may identify the color index values for sample positions in the CU. Whether the sample position is associated with an escape color may be determined based on a color index value associated with the sample position on the palette index map. In FIG. 5, FIG. 6, and FIG. 7, a patterned pixel includes a pixel position where both luma and chroma samples exist. A non-patterned pixel may include a pixel position where luma samples (e.g., luma samples only exist). A pixel position may or may not correspond to a patterned pixel position in one or more pixel sets. For example, the pixel position may correspond to a patterned pixel position in one or more pixel sets. The pixel position may be associated with an escape color. The pixel may correspond to the remaining pixels (e.g., the non-patterned pixels) in the same pixel set. The video coding device may determine whether to signal the chroma sample values of the pixel or sample position (e.g., in a coding block) based on whether the pixel position or the sample position) corresponds to a patterned pixel position when the pixel position is associated with (e.g., coded as) an escape color. For example, on a condition that the pixel position corresponds to a patterned pixel position, the sample values of the chroma components may be quantized and/or signaled. For example, the chroma components may be recovered. The chroma components may be recovered based on a decoded escape color value for the chroma components associated with the sample position. On a condition that the pixel position corresponds to a non-patterned pixel position when the pixel position is associated with (e.g., coded as) an escape color, the sample values of the chroma components may be omitted. For example, the sample values of the chroma components may or may not be quantized or signaled. The chroma components associated with the sample position may be signaled on the condition that the sample position is associated with at least one chroma component in the non-444 chroma format. The chroma component associated with the sample position may not be signaled on the condition that the sample position is only associated with a luma component.

The video coding device may be configured to quantize the luma sample, for example, if the video coding device determines that the escape color pixel position corresponds to the remaining pixels in the same set. The video coding device may be configured to signal in the bit-stream the luma sample, for example, if the video coding device determines that the escape color pixel position corresponds to the remaining pixels in the same set. The luma component of the escape color positions may always be quantized and signaled, whether the positions are patterned or non-patterned.

The palette table and palette index map for non-4:4:4 video may be generated.

The palette table and the palette index map of the current CU may be derived by taking luma or chroma components (e.g., Y, Cb and Cr in YCbCr color format) of one or more (e.g., each) pixels into consideration. For videos in the 4:4:4 chroma format, the luma component and two chroma components may have similar impacts on the overall performance of the CUs coded with the palette mode. As described herein, the luma and chroma components of non-4:4:4 chroma formats may contribute unequally to the reconstructed samples of the current CU. The non-4:4:4 palette coding may generate the palette table and the palette indices with the consideration of the respective contributions of different components to the final reconstruction process. Based on the example as depicted in FIG. 7, FIG. 8 and FIG. 9, in one or more (e.g., each) pixel sets, for the patterned pixel position, both the values of its luma and chroma samples may be used to generate the palette table and the palette index map of the current CU. For other pixel positions (e.g., the non-patterned pixels) in the same pixel set, the value of the luma sample for the pixel may be used to generate the palette table and the palette index map. Formulas (1) and (2) described above may become

$$\begin{matrix}{{arg min}_{S} ( {\sum }_{i = 0}^{K - 1} {\sum }_{c ∈ {S}_{i} , c ∈ {D}^{+}} {\sum }_{h = 0}^{2} ‖ {c}^{h} - {μ}_{i}^{h} ‖ + {\sum }_{i = 0}^{K - 1} {\sum }_{c ∈ {S}_{i} , c ∈ {D}^{*}} ‖ {c}^{0} - {μ}_{i}^{0} ‖ )}_{S} & ( 6 ) \\ {i}^{*} = \{ \begin{matrix}{arg min}_{i} {\sum }_{h = 0}^{2} ‖ {c}^{h} - {μ}_{i}^{h} ‖ , & c ∈ {D}^{+} \\ {arg min}_{i} ‖ {c}^{0} - {μ}_{i}^{0} ‖ , & c ∈ {D}^{*}\end{matrix} & ( 7 )\end{matrix}$$

Parameters D̂+ and D̂* represent the set of pixels for which the luma and chroma samples may be used to reconstruct the output CU and the set of pixels for which the luma samples may be used to reconstruct the output CU respectively.

The non-4:4:4 palette coding herein may be operated independently with the palette table and palette index map generation implementation. For example, the generation implementations of the palette table and palette index for 4:4:4 palette coding may be combined with the non-4:4:4 palette coding described herein to code CUs using the palette mode. The palette table and palette index generation as shown in equation (6) and (7) may be combined with the non-4:4:4 palette coding described herein to code CUs using the palette mode. The palette table and palette index generation as shown in equation (6) and (7) may be combined with the non-4:4:4 palette coding to code CUs using the palette mode when the video coding device is configured to code pixel positions as an escape colors.

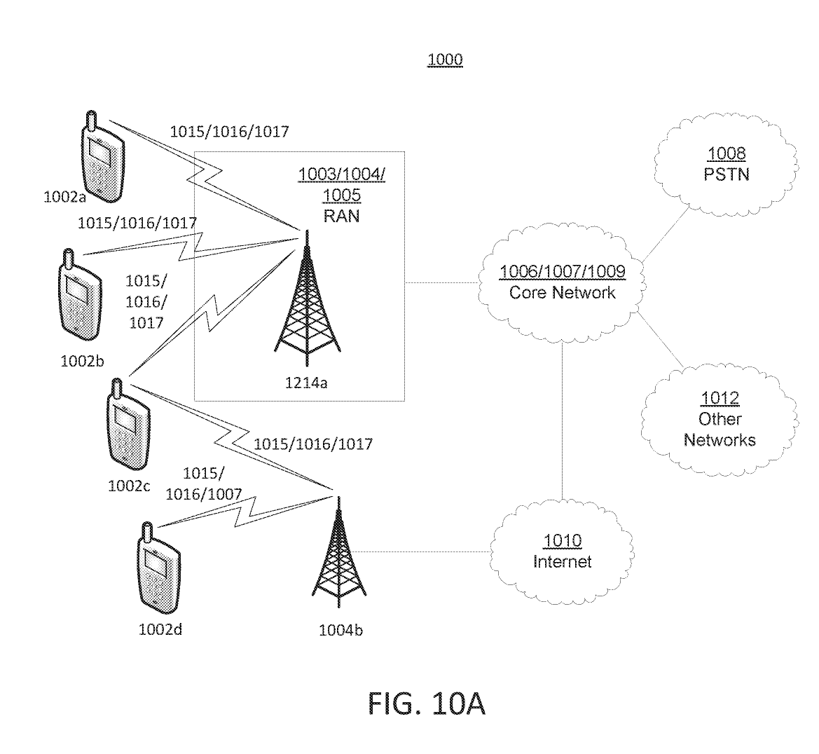

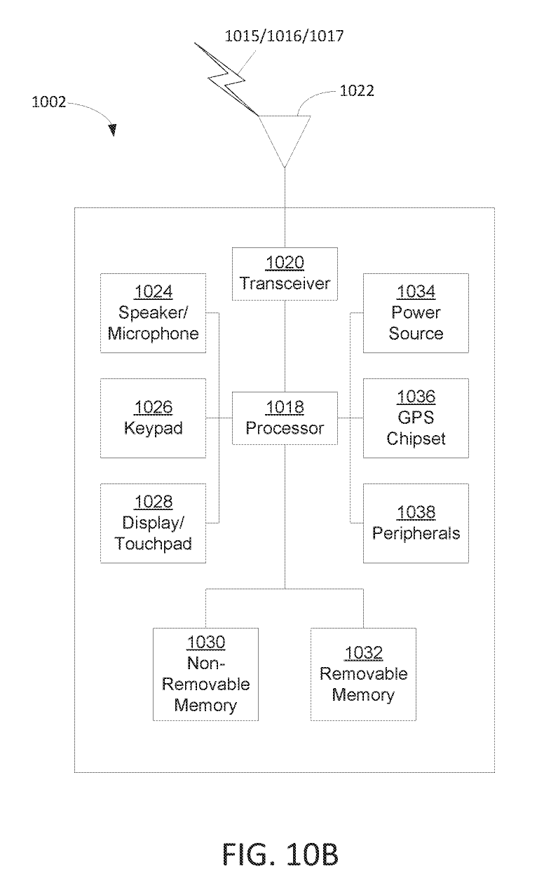

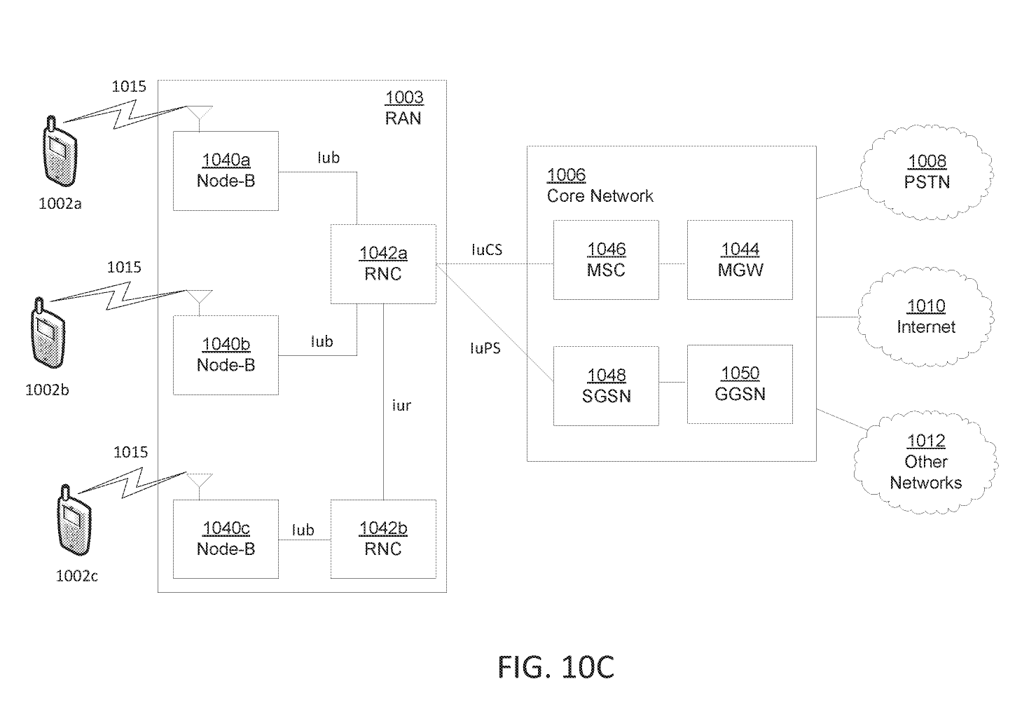

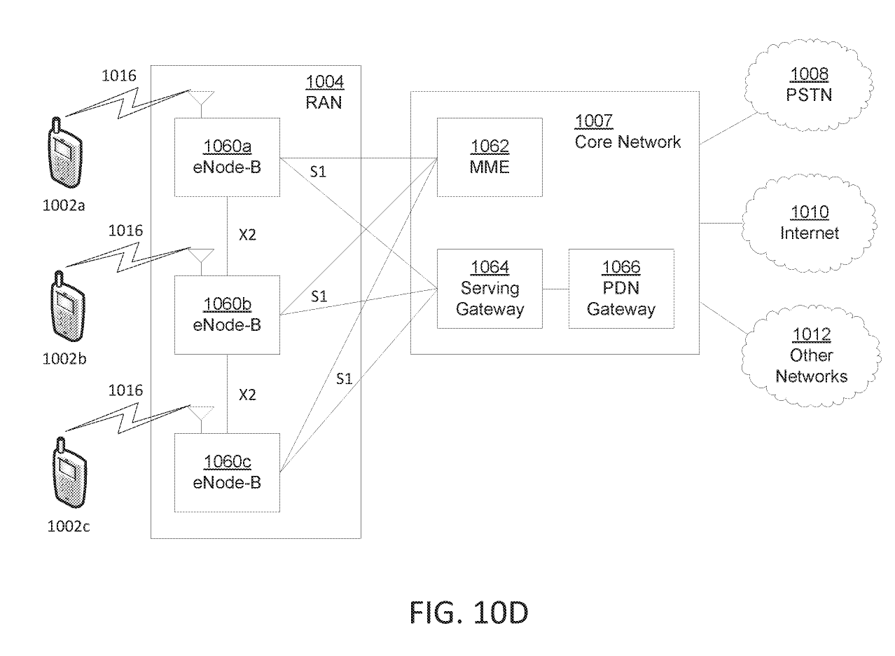

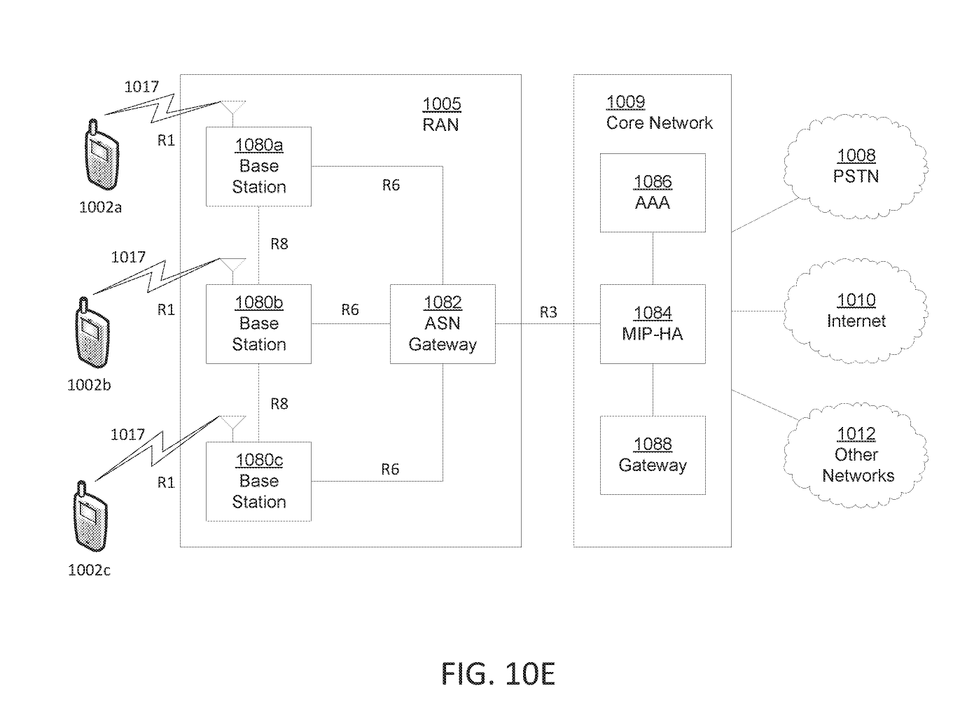

FIG. 10A is a diagram of an example communications system 1000 in which one or more disclosed embodiments may be implemented. The communications system 1000 may be a multiple access system that provides content, such as voice, data, video, messaging, broadcast, etc., to multiple wireless users. The communications system 1000 may enable multiple wireless users to access such content through the sharing of system resources, including wireless bandwidth. For example, the communications systems 1000 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 10A, the communications system 1000 may include wireless transmit/receive units (WTRUs) 1002a. 1002b, 1002c, and/or 1002d (which generally or collectively may be referred to as WTRU 1002), a radio access network (RAN) 1003/1004/1005, a core network 1006/1007/1009, a public switched telephone network (PSTN) 1008, the Internet 1010, and other networks 1012, though it will be appreciated that the disclosed embodiments contemplate any number of WTRUs, base stations, networks, and/or network elements. Each of the WTRUs 1002a, 1002b, 1002c, 1002d may be any type of device configured to operate and/or communicate in a wireless environment. By way of example, the WTRUs 1002a, 1002b, 1002c, 1002d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1000 may also include a base station 1014a and a base station 1014b. Each of the base stations 1014a, 1014b may be any type of device configured to wirelessly interface with at least one of the WTRUs 1002a, 1002b, 1002c, 1002d to facilitate access to one or more communication networks, such as the core network 1006/1007/1009, the Internet 1010, and/or the networks 1012. By way of example, the base stations 1014a, 1014b may be a base transceiver station (BTS), a Node-B, an eNode B, a Home Node B, a Home eNode B, a site controller, an access point (AP), a wireless router, and the like. While the base stations 1014a, 1014b are each depicted as a single element, it will be appreciated that the base stations 1014a, 1014b may include any number of interconnected base stations and/or network elements.

The base station 1014a may be part of the RAN 1003/1004/1005, which may also include other base stations and/or network elements (not shown), such as a base station controller (BSC), a radio network controller (RNC), relay nodes, etc. The base station 1014a and/or the base station 1014b may be configured to transmit and/or receive wireless signals within a particular geographic region, which may be referred to as a cell (not shown). The cell may further be divided into cell sectors. For example, the cell associated with the base station 1014a may be divided into three sectors. Thus, in one embodiment, the base station 1014a may include three transceivers, i.e., one for each sector of the cell. In another embodiment, the base station 1014a may employ multiple-input multiple output (MIMO) technology and, therefore, may utilize multiple transceivers for each sector of the cell.

The base stations 1014a, 1014b may communicate with one or more of the WTRUs 1002a, 1002b. 1002c, 1002d over an air interface 1015/1016/1017, which may be any suitable wireless communication link (e.g., radio frequency (RF), microwave, infrared (IR), ultraviolet (UV), visible light, etc.). The air interface 1015/1016/1017 may be established using any suitable radio access technology (RAT).

More specifically, as noted above, the communications system 1000 may be a multiple access system and may employ one or more channel access schemes, such as CDMA, TDMA. FDMA, OFDMA, SC-FDMA, and the like. For example, the base station 1014a in the RAN 1003/1004/1005 and the WTRUs 1002a, 1002b, 1002c may implement a radio technology such as Universal Mobile Telecommunications System (UMTS) Terrestrial Radio Access (UTRA), which may establish the air interface 1015/1016/1017 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 1014a and the WTRUs 1002a, 1002b, 1002c may implement a radio technology such as Evolved UMTS Terrestrial Radio Access (E-UTRA), which may establish the air interface 1015/1016/1017 using Long Term Evolution (LTE) and/or LTE-Advanced (LTE-A).

In other embodiments, the base station 1014a and the WTRUs 1002a, 1002b, 1002c may implement radio technologies such as IEEE 802.16 (i.e., Worldwide Interoperability for Microwave Access (WiMAX)), CDMA2000, CDMA2000 IX, CDMA2000 EV-DO. Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1014b in FIG. 10A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 1014b and the WTRUs 1002c, 1002d may implement a radio technology such as IEEE 802.11 to establish a wireless local area network (WLAN). In another embodiment, the base station 1014b and the WTRUs 1002c, 1002d may implement a radio technology such as IEEE 802.15 to establish a wireless personal area network (WPAN). In yet another embodiment, the base station 1014b and the WTRUs 1002c, 1002d may utilize a cellular-based RAT (e.g., WCDMA, CDMA2000, GSM, LTE, LTE-A, etc.) to establish a picocell or femtocell. As shown in FIG. 10A, the base station 1014b may have a direct connection to the Internet 1010. Thus, the base station 1014b may not be required to access the Internet 1010 via the core network 1006/1007/1009.

The RAN 1003/1004/1005 may be in communication with the core network 1006/1007/1009, which may be any type of network configured to provide voice, data, applications, and/or voice over internet protocol (VoIP) services to one or more of the WTRUs 1002a, 1002b, 1002c, 1002d. For example, the core network 1006/1007/1009 may provide call control, billing services, mobile location-based services, pre-paid calling, Internet connectivity, video distribution, etc., and/or perform high-level security functions, such as user authentication. Although not shown in FIG. 10A, it will be appreciated that the RAN 1003/1004/1005 and/or the core network 1006/1007/1009 may be in direct or indirect communication with other RANs that employ the same RAT as the RAN 1003/1004/1005 or a different RAT. For example, in addition to being connected to the RAN 1003/1004/1005, which may be utilizing an E-UTRA radio technology, the core network 1006/1007/1009 may also be in communication with another RAN (not shown) employing a GSM radio technology.

The core network 1006/1007/1009 may also serve as a gateway for the WTRUs 1002a, 1002b, 1002c, 1002d to access the PSTN 1008, the Internet 1010, and/or other networks 1012. The PSTN 1008 may include circuit-switched telephone networks that provide plain old telephone service (POTS). The Internet 1010 may include a global system of interconnected computer networks and devices that use common communication protocols, such as the transmission control protocol (TCP), user datagram protocol (UDP) and the internet protocol (IP) in the TCP/IP internet protocol suite. The networks 1012 may include wired or wireless communications networks owned and/or operated by other service providers. For example, the networks 1012 may include another core network connected to one or more RANs, which may employ the same RAT as the RAN 1003/1004/1005 or a different RAT.

Some or all of the WTRUs 1002a, 1002b, 1002c, 1002d in the communications system 1000 may include multi-mode capabilities, i.e., the WTRUs 1002a, 1002b, 1002c, 1002d may include multiple transceivers for communicating with different wireless networks over different wireless links. For example, the WTRU 1002c shown in FIG. 10A may be configured to communicate with the base station 1014a, which may employ a cellular-based radio technology, and with the base station 1014b, which may employ an IEEE 802 radio technology.

FIG. 10B is a system diagram of an example WTRU 1002. As shown in FIG. 10B, the WTRU 1002 may include a processor 1018, a transceiver 1020, a transmit/receive element 1022, a speaker/microphone 1024, a keypad 1026, a display/touchpad 1028, non-removable memory 1030, removable memory 1032, a power source 1034, a global positioning system (GPS) chipset 1036, and other peripherals 1038. It will be appreciated that the WTRU 1002 may include any sub-combination of the foregoing elements while remaining consistent with an embodiment. Also, embodiments contemplate that the base stations 1014a and 1014b, and/or the nodes that base stations 1014a and 1014b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 10B and described herein.

The processor 1018 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1018 may perform signal coding, data processing, power control, input/output processing, and/or any other functionality that enables the WTRU 1002 to operate in a wireless environment. The processor 1018 may be coupled to the transceiver 1020, which may be coupled to the transmit/receive element 1022. While FIG. 10B depicts the processor 1018 and the transceiver 1020 as separate components, it will be appreciated that the processor 1018 and the transceiver 1020 may be integrated together in an electronic package or chip.

The transmit/receive element 1022 may be configured to transmit signals to, or receive signals from, a base station (e.g., the base station 1014a) over the air interface 1015/1016/1017. For example, in one embodiment, the transmit/receive element 1022 may be an antenna configured to transmit and/or receive RF signals. In another embodiment, the transmit/receive element 1022 may be an emitter/detector configured to transmit and/or receive IR. UV, or visible light signals, for example. In yet another embodiment, the transmit/receive element 1022 may be configured to transmit and receive both RF and light signals. It will be appreciated that the transmit/receive element 1022 may be configured to transmit and/or receive any combination of wireless signals.

In addition, although the transmit/receive element 1022 is depicted in FIG. 10B as a single element, the WTRU 1002 may include any number of transmit/receive elements 1022. More specifically, the WTRU 1002 may employ MIMO technology. Thus, in one embodiment, the WTRU 1002 may include two or more transmit/receive elements 1022 (e.g., multiple antennas) for transmitting and receiving wireless signals over the air interface 1015/1016/1017.

The transceiver 1020 may be configured to modulate the signals that are to be transmitted by the transmit/receive element 1022 and to demodulate the signals that are received by the transmit/receive element 1022. As noted above, the WTRU 1002 may have multi-mode capabilities. Thus, the transceiver 1020 may include multiple transceivers for enabling the WTRU 1002 to communicate via multiple RATs, such as UTRA and IEEE 802.11, for example.

The processor 1018 of the WTRU 1002 may be coupled to, and may receive user input data from, the speaker/microphone 1024, the keypad 1026, and/or the display/touchpad 1028 (e.g., a liquid crystal display (LCD) display unit or organic light-emitting diode (OLED) display unit). The processor 1018 may also output user data to the speaker/microphone 1024, the keypad 1026, and/or the display/touchpad 1028. In addition, the processor 1018 may access information from, and store data in, any type of suitable memory, such as the non-removable memory 1030 and/or the removable memory 1032. The non-removable memory 1030 may include random-access memory (RAM), read-only memory (ROM), a hard disk, or any other type of memory storage device. The removable memory 1032 may include a subscriber identity module (SIM) card, a memory stick, a secure digital (SD) memory card, and the like. In other embodiments, the processor 1018 may access information from, and store data in, memory that is not physically located on the WTRU 1002, such as on a server or a home computer (not shown).

The processor 1018 may receive power from the power source 1034, and may be configured to distribute and/or control the power to the other components in the WTRU 1002. The power source 1034 may be any suitable device for powering the WTRU 1002. For example, the power source 1034 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1018 may also be coupled to the GPS chipset 1036, which may be configured to provide location information (e.g., longitude and latitude) regarding the current location of the WTRU 1002. In addition to, or in lieu of, the information from the GPS chipset 1036, the WTRU 1002 may receive location information over the air interface 1015/1016/1017 from a base station (e.g., base stations 1014a, 1014b) and/or determine its location based on the timing of the signals being received from two or more nearby base stations. It will be appreciated that the WTRU 1002 may acquire location information by way of any suitable location-determination implementation while remaining consistent with an embodiment.

The processor 1018 may further be coupled to other peripherals 1038, which may include one or more software and/or hardware modules that provide additional features, functionality and/or wired or wireless connectivity. For example, the peripherals 1038 may include an accelerometer, an e-compass, a satellite transceiver, a digital camera (for photographs or video), a universal serial bus (USB) port, a vibration device, a television transceiver, a hands free headset, a Bluetooth, module, a frequency modulated (FM) radio unit, a digital music player, a media player, a video game player module, an Internet browser, and the like.

FIG. 10C is a system diagram of the RAN 1003 and the core network 1006 according to an embodiment. As noted above, the RAN 1003 may employ a UTRA radio technology to communicate with the WTRUs 1002a. 1002b. 1002c over the air interface 1015. The RAN 1003 may also be in communication with the core network 1006. As shown in FIG. 10C, the RAN 1003 may include Node-Bs 1040a, 1040b, 1040c, which may each include one or more transceivers for communicating with the WTRUs 1002a, 1002b, 1002c over the air interface 1015. The Node-Bs 1040a, 1040b, 1040c may each be associated with a particular cell (not shown) within the RAN 1003. The RAN 1003 may also include RNCs 1042a. 1042b. It will be appreciated that the RAN 1003 may include any number of Node-Bs and RNCs while remaining consistent with an embodiment.

As shown in FIG. 10C, the Node-Bs 1040a, 1040b may be in communication with the RNC 1042a. Additionally, the Node-B 1040c may be in communication with the RNC 1042b. The Node-Bs 1040a, 1040b, 1040c may communicate with the respective RNCs 1042a, 1042b via an Iub interface. The RNCs 1042a, 1042b may be in communication with one another via an Iur interface. Each of the RNCs 1042a. 1042b may be configured to control the respective Node-Bs 1040a, 1040b, 1040c to which it is connected. In addition, each of the RNCs 1042a, 1042b may be configured to carry out or support other functionality, such as outer loop power control, load control, admission control, packet scheduling, handover control, macrodiversity, security functions, data encryption, and the like.

The core network 1006 shown in FIG. 10C may include a media gateway (MGW) 1044, a mobile switching center (MSC) 1046, a serving GPRS support node (SGSN) 1048, and/or a gateway GPRS support node (GGSN) 1050. While each of the foregoing elements are depicted as part of the core network 1006, it will be appreciated that any one of these elements may be owned and/or operated by an entity other than the core network operator.

The RNC 1042a in the RAN 1003 may be connected to the MSC 1046 in the core network 1006 via an IuCS interface. The MSC 1046 may be connected to the MGW 1044. The MSC 1046 and the MGW 1044 may provide the WTRUs 1002a, 1002b, 1002c with access to circuit-switched networks, such as the PSTN 1008, to facilitate communications between the WTRUs 1002a, 1002b, 1002c and traditional land-line communications devices.

The RNC 1042a in the RAN 1003 may also be connected to the SGSN 1048 in the core network 1006 via an IuPS interface. The SGSN 1048 may be connected to the GGSN 1050. The SGSN 1048 and the GGSN 1050 may provide the WTRUs 1002a. 1002b, 1002c with access to packet-switched networks, such as the Internet 1010, to facilitate communications between and the WTRUs 1002a, 1002b, 1002c and IP-enabled devices.

As noted above, the core network 1006 may also be connected to the networks 1012, which may include other wired or wireless networks that are owned and/or operated by other service providers.

FIG. 10D is a system diagram of the RAN 1004 and the core network 1007 according to an embodiment. As noted above, the RAN 1004 may employ an E-UTRA radio technology to communicate with the WTRUs 1002a. 1002b, 1002c over the air interface 1016. The RAN 1004 may also be in communication with the core network 1007.

The RAN 1004 may include eNode-Bs 1060a, 1060b, 1060c, though it will be appreciated that the RAN 1004 may include any number of eNode-Bs while remaining consistent with an embodiment. The eNode-Bs 1060a, 1060b, 1060c may each include one or more transceivers for communicating with the WTRUs 1002a, 1002b, 1002c over the air interface 1016. In one embodiment, the eNode-Bs 1060a. 1060b, 1060c may implement MIMO technology. Thus, the eNode-B 1060a, for example, may use multiple antennas to transmit wireless signals to, and receive wireless signals from, the WTRU 1002a.

Each of the eNode-Bs 1060a, 1060b, 1060c may be associated with a particular cell (not shown) and may be configured to handle radio resource management decisions, handover decisions, scheduling of users in the uplink and/or downlink, and the like. As shown in FIG. 10D, the eNode-Bs 1060a, 1060b, 1060c may communicate with one another over an X2 interface.

The core network 1007 shown in FIG. 10D may include a mobility management gateway (MME) 1062, a serving gateway 1064, and a packet data network (PDN) gateway 1066. While each of the foregoing elements are depicted as part of the core network 1007, it will be appreciated that any one of these elements may be owned and/or operated by an entity other than the core network operator.

The MME 1062 may be connected to each of the eNode-Bs 1060a, 1060b, 1060c in the RAN 1004 via an S1 interface and may serve as a control node. For example, the MME 1062 may be responsible for authenticating users of the WTRUs 1002a, 1002b, 1002c, bearer activation/deactivation, selecting a particular serving gateway during an initial attach of the WTRUs 1002a, 1002b, 1002c, and the like. The MME 1062 may also provide a control plane function for switching between the RAN 1004 and other RANs (not shown) that employ other radio technologies, such as GSM or WCDMA.

The serving gateway 1064 may be connected to each of the eNode-Bs 1060a, 1060b, 1060c in the RAN 1004 via the S1 interface. The serving gateway 1064 may generally route and forward user data packets to/from the WTRUs 1002a. 1002b, 1002c. The serving gateway 1064 may also perform other functions, such as anchoring user planes during inter-eNode B handovers, triggering paging when downlink data is available for the WTRUs 1002a, 1002b, 1002c, managing and storing contexts of the WTRUs 1002a, 1002b, 1002c, and the like.

The serving gateway 1064 may also be connected to the PDN gateway 1066, which may provide the WTRUs 1002a, 1002b, 1002c with access to packet-switched networks, such as the Internet 1010, to facilitate communications between the WTRUs 1002a, 1002b, 1002c and IP-enabled devices.

The core network 1007 may facilitate communications with other networks. For example, the core network 1007 may provide the WTRUs 1002a, 1002b, 1002c with access to circuit-switched networks, such as the PSTN 1008, to facilitate communications between the WTRUs 1002a, 1002b, 1002c and traditional land-line communications devices. For example, the core network 1007 may include, or may communicate with, an IP gateway (e.g., an IP multimedia subsystem (IMS) server) that serves as an interface between the core network 1007 and the PSTN 1008. In addition, the core network 1007 may provide the WTRUs 1002a, 1002b, 1002c with access to the networks 1012, which may include other wired or wireless networks that are owned and/or operated by other service providers.

FIG. 10E is a system diagram of the RAN 1005 and the core network 1009 according to an embodiment. The RAN 1005 may be an access service network (ASN) that employs IEEE 802.16 radio technology to communicate with the WTRUs 1002a, 1002b, 1002c over the air interface 1017. As will be further discussed below, the communication links between the different functional entities of the WTRUs 1002a. 1002b, 1002c, the RAN 1005, and the core network 1009 may be defined as reference points.

As shown in FIG. 10E, the RAN 1005 may include base stations 1080a, 1080b. 1080c, and an ASN gateway 1082, though it will be appreciated that the RAN 1005 may include any number of base stations and ASN gateways while remaining consistent with an embodiment. The base stations 1080a, 1080b, 1080c may each be associated with a particular cell (not shown) in the RAN 1005 and may each include one or more transceivers for communicating with the WTRUs 1002a, 1002b, 1002c over the air interface 1017. In one embodiment, the base stations 1080a, 1080b, 1080c may implement MIMO technology. Thus, the base station 1080a, for example, may use multiple antennas to transmit wireless signals to, and receive wireless signals from, the WTRU 1002a. The base stations 1080a, 1080b, 1080c may also provide mobility management functions, such as handoff triggering, tunnel establishment, radio resource management, traffic classification, quality of service (QoS) policy enforcement, and the like. The ASN gateway 1082 may serve as a traffic aggregation point and may be responsible for paging, caching of subscriber profiles, routing to the core network 1009, and the like.

The air interface 1017 between the WTRUs 1002a, 1002b, 1002c and the RAN 1005 may be defined as an R1 reference point that implements the IEEE 802.16 specification. In addition, each of the WTRUs 1002a, 1002b, 1002c may establish a logical interface (not shown) with the core network 1009. The logical interface between the WTRUs 1002a, 1002b, 1002c and the core network 1009 may be defined as an R2 reference point, which may be used for authentication, authorization, IP host configuration management, and/or mobility management.

The communication link between each of the base stations 1080a. 1080b, 1080c may be defined as an R8 reference point that includes protocols for facilitating WTRU handovers and the transfer of data between base stations. The communication link between the base stations 1080a, 1080b, 1080c and the ASN gateway 1082 may be defined as an R6 reference point. The R6 reference point may include protocols for facilitating mobility management based on mobility events associated with each of the WTRUs 1002a, 1002b, 1002c.

As shown in FIG. 10E, the RAN 1005 may be connected to the core network 1009. The communication link between the RAN 1005 and the core network 1009 may defined as an R3 reference point that includes protocols for facilitating data transfer and mobility management capabilities, for example. The core network 1009 may include a mobile IP home agent (MIP-HA) 1084, an authentication, authorization, accounting (AAA) server 1086, and a gateway 1088. While each of the foregoing elements are depicted as part of the core network 1009, it will be appreciated that any one of these elements may be owned and/or operated by an entity other than the core network operator.

The MIP-HA may be responsible for IP address management, and may enable the WTRUs 1002a, 1002b, 1002c to roam between different ASNs and/or different core networks. The MIP-HA 1084 may provide the WTRUs 1002a, 1002b, 1002c with access to packet-switched networks, such as the Internet 1010, to facilitate communications between the WTRUs 1002a, 1002b, 1002c and IP-enabled devices. The AAA server 1086 may be responsible for user authentication and for supporting user services. The gateway 1088 may facilitate interworking with other networks. For example, the gateway 1088 may provide the WTRUs 1002a, 1002b, 1002c with access to circuit-switched networks, such as the PSTN 1008, to facilitate communications between the WTRUs 1002a, 1002b, 1002c and traditional land-line communications devices. In addition, the gateway 1088 may provide the WTRUs 1002a, 1002b, 1002c with access to the networks 1012, which may include other wired or wireless networks that are owned and/or operated by other service providers.

Although not shown in FIG. 10E, it will be appreciated that the RAN 1005 may be connected to other ASNs and the core network 1009 may be connected to other core networks. The communication link between the RAN 1005 the other ASNs may be defined as an R4 reference point, which may include protocols for coordinating the mobility of the WTRUs 1002a, 1002b. 1002c between the RAN 1005 and the other ASNs. The communication link between the core network 1009 and the other core networks may be defined as an R5 reference, which may include protocols for facilitating interworking between home core networks and visited core networks.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method for palette decoding a video bit-stream associated with a first chroma format, the method comprising:
receiving data defining a palette table and a palette index map associated with a coding unit (CU), the palette table and the palette index map being associated with a second chroma format, wherein the palette index map is associated with luma and chroma sample values of the second chroma format;
for a first chroma sample position associated with the first chroma format, deriving a chroma sample position associated with the second chroma format on the palette index map associated with the second chroma format based on a luma component to chroma component resolution ratio associated with the first chroma format; and
determining a respective chroma sample value for the chroma sample position associated with the first chroma format based on the derived chroma sample position associated with the second chroma format, the palette index map associated with the second chroma format, and the palette table.

2. The method of claim 1, wherein the palette table comprises a plurality of chroma sample values corresponding to a plurality of colors in the CU, and the palette index map associated with the second chroma format identifies respective color index values for sample positions in the CU, the method further comprising:
determining a color index value associated with the chroma sample position associated with the second chroma format on the palette index map associated with the second chroma format; and
look up the respective chroma sample value in the palette table based on the color index value.

3. The method of claim 1, further comprising:
for a luma sample position associated with the first chroma format, determining a respective luma sample value based on the luma sample position, the palette index map associated with the second chroma format and the palette table.

4. The method of claim 3, wherein the palette table comprises a plurality of chroma sample and luma sample values corresponding to a plurality of colors in the CU, and the palette index map associated with the second chroma format identifies respective color index values for sample positions in the CU, the method further comprising:
determining a color index value associated with the luma sample position; and
looking up the respective luma sample value in the palette table based on the color index value.

5. The method of claim 1, further comprising:
identifying a sample position in the CU;
determining whether the sample position is associated with a luma component only based on the sample position and the first chroma format; and
discarding a chroma sample value associated with the sample position based on a determination that the sample position is associated with the luma component only.

6. The method of claim 1, wherein the first chroma format is a non-4:4:4 chroma format and the second chroma format is a 4:4:4 chroma format.

7. The method of claim 6, wherein the non-4:4:4 chroma format is 4:2:0, 4:2:2 or 4:0:0.

8. The method of claim 1, the method further comprising:
determining whether a sample position in the CU is associated with an escape color;
based on a determination that the sample position is associated with the escape color, determining whether a chroma component associated with the sample position is signaled based on the sample position and the first chroma format; and
based on a determination that the chroma component associated with the sample position is signaled, recovering the chroma component associated with the sample position.

9. The method of claim 8, wherein the chroma component associated with the sample position is recovered based on a decoded escape color value for the chroma component associated with the sample position.

10. The method of claim 8, wherein the palette table comprises a plurality of chroma sample values corresponding to a plurality of colors in the CU, the palette index map associated with the second chroma format identifies respective color index values for sample positions in the CU, and whether the sample position is associated with an escape color is determined based on a color index value associated with the sample position on the palette index map associated with the second chroma format.

11-14. (canceled)

15. A method for palette encoding a video, the method comprising:
receiving a video block associated with a first chroma format, the video block comprising a plurality of chroma sample positions and a plurality of luma sample positions;
upsampling the plurality of chroma sample positions in accordance with a second chroma format;
deriving a palette table and a palette index map associated with the second chroma format based on the upsampled plurality of chroma sample positions and the plurality of luma sample positions; and
encoding the palette table and the palette index map associated with the second chroma format in a video bit-stream, wherein the palette index map is associated with luma and chroma sample values of the second chroma format.

16. The method of claim 15, wherein chroma sample positions near a luma sample position are used for upsampling the plurality of chroma sample positions.

17. The method of claim 15, wherein chroma sample positions closest in phase distance to a luma sample position are used for upsampling the plurality of chroma sample positions.

18. The method of claim 15, wherein an interpolation-based upsampling is used for upsampling the plurality of chroma sample positions, wherein the interpolation-based upsampling is based on chroma sample positions near a luma sample position and a phase distance between the chroma sample positions and the luma sample position.

19. The method of claim 15, wherein a chroma sample value associated with a second sample position is encoded, wherein the second sample position is associated with a luma sample value only.

20-27. (canceled)

28. A video coding device for palette decoding a video bit-stream associated with a first chroma format, the video coding device comprising:
a processor configured to:
receive data defining a palette table and a palette index map associated with a coding unit (CU), the palette table and the palette index map being associated with a second chroma format, wherein the palette index map is associated with luma and chroma sample values of the second chroma format;
for a first chroma sample position associated with the first chroma format, derive a chroma sample position associated with the second chroma format on the palette index map associated with the second chroma format based on a luma component to chroma component resolution ratio associated with the first chroma format; and
determine a respective chroma sample value for the chroma sample position associated with the first chroma format based on the derived chroma sample position associated with the second chroma format, the palette index map associated with the second chroma format, and the palette table.

29. The video coding device of claim 28, wherein the palette table comprises a plurality of chroma sample values corresponding to a plurality of colors in the CU, and the palette index map associated with the second chroma format identifies respective color index values for sample positions in the CU, and the process is further configured to:
determine a color index value associated with the chroma sample position associated with the second chroma format on the palette index map associated with the second chroma format; and
look up the respective chroma sample value in the palette table based on the color index value.

30. The video coding device of claim 28, wherein the process is further configured to:
for a luma sample position associated with the first chroma format, determine a respective luma sample value based on the luma sample position, the palette index map associated with the second chroma format, and the palette table.

31. The video coding device of claim 30, wherein the palette table comprises a plurality of chroma sample and luma sample values corresponding to a plurality of colors in the CU, and the palette index map associated with the second chroma format identifies respective color index values for sample positions in the CU, and the process is further configured to:
determine a color index value associated with the luma sample position; and
look up the respective luma sample value in the palette table based on the color index value.

32. The video coding device of claim 28, wherein the process is further configured to:
identify a sample position in the CU;
determine whether the sample position is associated with a luma component only based on the sample position and the first chroma format; and
discard a chroma sample value associated with the sample position based on a determination that the sample position is associated with the luma component only.

33-54. (canceled)
